(19) United States
(12) Patent Application Publication
(10) Pub. No.: US 2019/0197867 A1
(43) Pub. Date: Jun. 27, 2019

(54) SENSOR SYSTEM AND METHOD

(71) Applicant: MENI MENASHE ZINGER, ASHKELON (IL)

(72) Inventor: MENI MENASHE ZINGER, ASHKELON (IL)

(21) Appl. No.: 16/327,874

(22) PCT Filed: Aug. 27, 2017
(86) PCT No.: PCT/IL2017/050949

§ 371 Date: Feb. 25, 2019

Related U.S. Application Data
(60) Provisional application No. 62/379,284, filed on Aug. 25, 2016.

(51) Int. Cl. G08B 21/08; H04N 7/18

(52) U.S. Cl. CPC G08B 21/08; H04N 7/188; H04N 7/181

(57) ABSTRACT

A system and method for detecting the presence of an immobile object in an unattended container of liquid such as a bathtub or swimming pool. The system may include at least one sensor or include an array of sensors located at the bottom of the container, a remotely located controller, and an alarm signal generator. The controller is operative to process the sensor data to detect an object which has remained immobile for at least a predetermined time. The system includes an image generator to provide an attendant with a view of the area of the container at which the immobile body is located. At least one motion sensor is also provided in some embodiments.

A method is also disclosed that implements the functions of the system.

### RELATED APPLICATION

This application claims the benefit of U.S. Provisional Patent Application No. 62/379,284 filed on Aug. 25, 2016. The disclosure of this prior application is considered part thereof and its entire content is incorporated by reference in the disclosure of this application.

### FIELD OF THE INVENTION

The present invention, in some embodiments thereof, relates to sensor systems and methods, and, in particular, but not exclusively, to sensor systems and methods for sensing objects such as humans, animals, or inanimate objects in a pool or other contained body of water or other liquid and for facilitating identification of the object.

### BACKGROUND OF THE INVENTION

There always exists a risk that someone, particularly a child, or an animal will that are susceptible to drawing may fall into or otherwise suffer injury in an unattended body of water. Some degree of risk of such an accident is essentially unavoidable: instructions, warnings, fences or other barriers may provide protection for private swimming pools or public pools closed at night but may not deter a determined trespasser. Likewise, young children and at times older people often bathe without supervision, particularly in private swimming pools. Public pools and beaches are guarded during normal hours of use, but full proof guarding or even isolating bodies of water is virtually impossible.

Various systems have been proposed to address this problem, but for swimming pools, bath tubs, and even ritual baths, those commercially available are generally complex and costly. They tend to be intrusive and subject to risk of accidental or intentional damage and do not provide a robust drawing alarm system and method.

The present invention addresses these and other problems associated with known technology in this field.

### SUMMARY OF THE INVENTION

According to an aspect of some embodiments of the invention, there is provided a system for detecting an immobile object in a container of liquid, the container having an accessible bottom, the system including an array of sensors positioned in a spaced relationship at the bottom of the container, each sensor being configured to provide a proximity signal output indicating the presence of an object at the bottom of the container at the sensor location, a controller, a communication channel connecting the sensors to the controller; and an alarm signal generator, wherein the controller is operative to scan the outputs of the sensors in a repetitive sequence and responsive to a succession of proximity signals from a particular sensor that are substantially non-varying over a predetermined time period to activate the alarm signal generator.

According to some embodiments, there is also provided a visual image generator in communication with the controller to provide an image of the area of the container at which the immobile object is located.

According to some embodiments, the visual image generator includes a camera or image processing software operable by the controller to activate to generate an image of the area of the surface of the liquid above the particular sensor.

According to some embodiments, there is also provided at least one motion detector.

According to some embodiments, the sensors are arranged in a matrix array and are activated by row and column wires responsive to activation signals from the controller.

According to some embodiments, the sensors are integrated into a supporting platform that provides a waterproof environment for transmission of sensor output signals or are integrated into the bottom of the container at the time it is manufactured.

According to some embodiments, the platform is comprised of a rigid or resilient polymeric material.

According to some embodiments, the controller is operative to generate a baseline reference value for the sensors and to compare the actual sensor outputs with the baseline value to determine the presence of the immobile object.

According to some embodiments, the sensors are one or more of piezoelectric sensors, capacitive sensors, and photoelectric sensors.

According to some embodiments, signals are transmitted between the container sensors and the controller either by wire or wirelessly.

According to an aspect of the invention, there is provided a method for detecting an immobile object in a container of liquid having an accessible bottom, which includes positioning an array of sensors in a spaced relationship at the bottom of the container, each sensor being configured to provide a proximity signal output indicating the presence of an object at the bottom of the container at the sensor location, transmitting the sensor output signals to a controller through a communication channel, wherein the controller is operative to detect a proximity signal from a sensor that is constant for a predetermined period of time thereby indicating that the object is immobile; and

generating an alarm signal when an immobile object has been detected.

According to some embodiments, a visual image is generated of the area of the container at which the immobile object is located.

According to some embodiments, the visual image is generated by a camera, positionable to view selected areas of the surface of the liquid in the container or by performing image processing on the sensor output signals to generate an image of the immobile object.

According to some embodiments, there is also provided at least one motion detector to sense motion within the container.

According to some embodiments, the sensors are arranged in a matrix array and are activated by row and column wires responsive to activation signals from the controller.

According to some embodiments, the sensors are integrated into a supporting platform that provides a waterproof environment for transmission of sensor output signals or are integrated into the bottom of the container at the time it is manufactured.

According to some embodiments, the platform is comprised of a rigid or resilient polymeric material.

According to some embodiments, the method further includes generating a baseline reference value for the sensors and comparing the actual sensor outputs with the baseline value to determine the presence of the immobile object.

According to some embodiments, the sensors are one or more of piezoelectric sensors, capacitive sensors, and photoelectric sensors.

According to some embodiments, the method further includes transmitting signals between the container sensors and the controller either by wire or wirelessly.

Unless otherwise defined, all technical and/or scientific terms used in the following description have the same meaning as commonly understood by one of ordinary skill in the art to which the invention pertains. Although methods and materials similar or equivalent to those described can be used in the practice or testing of embodiments of the invention, exemplary methods and/or materials are described below. In case of conflict, the patent specification, including definitions, will control.

In addition, the materials, methods, and examples are illustrative only and are not intended to be limiting.

Implementation of the method and/or system of embodiments of the invention can involve performing or completing selected tasks manually, automatically, or a combination thereof Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The present invention will be further understood and appreciated from the following detailed description taken in conjunction with the drawings in which:

FIG. 1 is a schematic illustration of a sensor system constructed and operative in accordance with one embodiment of the present invention;

FIG. 2 illustrates an exemplary array of sensors; and

FIG. 3 is a function block diagram of a controller according some embodiments of the invention.

### DETAILED DESCRIPTION OF THE INVENTION

### Introductory Overview

The present invention, in some embodiments thereof, relates to sensor systems and methods, and, in particular, but not exclusively, to sensor systems and methods for detecting the presence of an immobile object in a contained body of water or other liquid and for facilitating identification of the object.

The term “object” is used herein in a broad sense and is intended to include human or animal bodies as well as inanimate objects. The term “contained body of water” or more simply “container” is also used in a broad sense and is intended to encompass swimming pools, bathtubs, showers, ritual baths or other bodies of water or other liquids having accessible bottoms, and optionally, one or more accessible side walls.

Broadly stated, according an aspect of some embodiments of the invention, the system includes one or more sensors designed to detect the presence of an immobile object on or in close proximity to a bottom surface of the container and a controller responsive to data provided by the sensors to raise an alarm or take other appropriate action.

It should be noted that for convenience, a singular term such as “sensor” will be used in a non-limiting sense to also encompass multiple sensors. Unless specifically noted otherwise, such terms should be understood in this non-limiting sense.

According to a feature of some embodiments, a plurality of sensors are provided that are positioned in fixed relationship to each other. Optionally, the sensors are mounted in or on a supporting platform such as pad or mat configured to be disposed on the bottom or floor of the container. Optionally multiple support platforms may be provided, each carrying a plurality of sensors.

Where a single support platform is provided for all the sensors, it may be so configured that a portion of it may also be disposed on one or more side walls of the container. Where multiple supports are provided, one or more of them may also be disposed on a side or sides of the container.

Optionally, multiple support platforms may be so constructed so they may be attached together physically and electrically as an integral unit of a desired size and configuration.

Preferably, one or more sensors on the bottom or a side wall of the container are positioned beneath the normal level of the liquid in the container.

Optionally, the sensors may be integrated into the structure of the container, rather than on or in a separate support platform.

According to an aspect of some embodiments of the invention, the sensors may be of various types suitable for the purposes of the invention. According to a feature of some embodiments, the sensors may be pressure sensors, contact sensors, motion sensors, photoelectric sensors, optical sensors etc. According to an optional feature of some embodiments, combinations of types of sensors may be employed.

According to an optional feature of some embodiments, one or more visual image sensors, for example, cameras, may be provided along with or instead of other types of sensors. Optionally, such image sensors may be fixed in position relative to the sensors.

Optionally, separate fixed-position cameras are associated with each sensor or with a subset of the sensors. Alternatively, according to a feature of some embodiments, one or more single cameras may be provided to scan multiple sensors, either in a fixed repetitive pattern or as directed by the controller for example, when an immobile object is detected by a sensor or multiple sensors.

According to an aspect of some embodiments of the invention, the controller is a programmable general purpose computer. Optionally it is a special purpose device including one or more application-specific integrated circuits designed to perform the functions required according to the present invention.

According to an aspect of some embodiments, the controller is operative to scan a succession of sensors and to process their respective outputs to identify sensors whose readings indicate the presence of an immobile object. According to a feature of some embodiments, the controller operates to identify sensors whose outputs do not change over a predetermined time period or which vary in one or more predetermined ways over time.

According to a feature of some embodiments of the invention, the sensor readings are compared to baseline values. Optionally, the baseline values are derived from readings of all or a subset of the sensors. Optionally, the baseline values are predetermined. Sensor readings that depart from the baseline values by a predetermined amount and, which remain so for a specified period are considered as indicating the presence of an immobile object.

In some embodiments, the sensors are connected in a wired array and each sensor output signals are transmitted to the controller through a wired communication channel. Optionally, the communication is at least partially wireless.

When considering the detailed description below, it should be understood that the features described above in reference to some embodiments are not limited to those specific embodiments but may be combined in different ways to form yet other embodiments that are also within the scope of the invention.

### DESCRIPTION OF AN EXEMPLARY EMBODIMENT

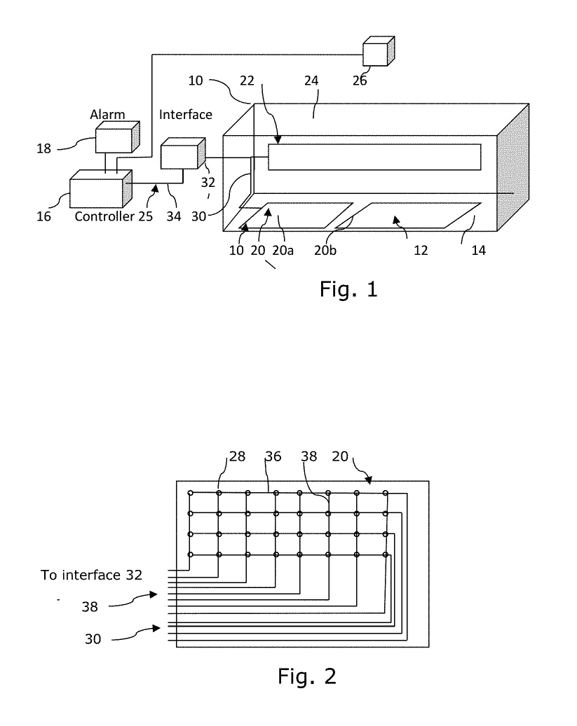

Referring now to FIG. 1, there is illustrated schematically a liquid container generally indicated at 10, intended to provide protection by the present invention. The sensor system is comprised of a sensor array generally denoted at 12 deployed at the bottom 14 of container 10, a controller 16, and an alarm system 18.

A motion sensor array 22 may optionally be mounted on one or more of container walls 24 or placed on the bottom 14. Also, optionally, one or more cameras 26 may be positioned nearby to provide a view of the container, for example, when the sensor system is employed in a swimming pool that is remotely monitored. It should be understood that cameras 26 may optionally be mounted on the bottom 14 or walls 24 and remotely monitored by the control to point towards sensors indicating a possible motionless object.

It should be understood that container 10 is shown as having uniform depth, but that it can also have a deep end and a shallow end, as is conventional for in-ground swimming pools.

In the illustrated embodiment, sensor array 12 is embedded in a support platform 20 resting on, and substantially covering container bottom 14. In the illustrated embodiment, platform 20 is comprised of two rectangular sections 20a and 20b, but it should be understood that one section or more than two sections can be used to cover the entire bottom 14 or the entire bottom 14 and side walls 14, or any part thereof. Also, non-rectangular platform sections may be provided for containers having non-rectangular bottom contours.

The sensors comprised in array 12 are intended to provide an indication such as a proximity signal indicating the presence of an object that is in contact with container bottom 14 or in close proximity thereto and may be of any type suitable for this purpose. Possibilities include piezoelectric pressure sensors, capacitive sensors, photoelectric sensors or others as will be apparent to those skilled in the art. The motion sensors comprised in array 22 may also be of any type suitable for the purpose, e.g., optical or acoustic. As will be appreciated, all sensors will be suitable for underwater use.

Supporting platform 20 is formed of a suitable waterproof or water resistant and durable material, e.g., a carbon-fiber reinforced polymeric material or rubber. Depending on the types of sensors employed, the material may be rigid or resilient. The material should be of sufficient density and thickness that it is negatively buoyant so that it remains flat on container bottom 14. Optionally, it is also anchored to container bottom 14, e.g., by a suitable adhesive or mechanical fasteners. Advantageously, the surface platform 20 is at least partially roughened to reduce the risk of slippage.

As in the case of sensor array 12, motion sensor array 22 may also be comprised of a plurality of spaced sensors mounted on a supporting platform similar to platform 20 and suitably attached to container walls 24. The supporting platform for sensors 22 may be neutrally buoyant if desired to avoid stress on the fasteners by which is attached to walls 24. Alternatively, the sensors may be attached directly to walls 24.

It should also be understood that mounting the sensor arrays 12 and 22 on supporting platforms provides a convenient way for implementing the invention for existing container installations. It is also possible, however for new pool installations, to integrate the sensors into the bottom and walls of a pool at the time of construction or installation either individually, or in arrays mounted on a suitable support. Sensor arrays can similarly be built into bath tubs when being manufactured.

In the illustrated embodiment of FIG. 1, sensors arrays 12 and 22 are connected to controller 16 by a communication channel generally denoted at 25 comprised of a cable 30 connected to the two arrays, a communication interface device 32 providing a wired connection or wireless communication, for example, through the internet or a LAN, as indicated at 34. The controller may be located, for example, in a parent's or other caregiver's room, in case of a private pool, or at a nearby control center, or at a remote location, such as a public emergency services center.

FIG. 2 illustrates a suitable construction for sensor array 12. The array is in the form of a matrix comprised of piezoelectric 28 sensors extending longitudinally and transversely along the length and width of a single support platform 20. A matrix of row wires 30 and column wires 38 configured to provide a waterproof connection to sensors 28 are selectively energized by interface unit 32 to provide paths for proximity signal outputs indicating that an object or part thereof has been sensed by a sensor 28, for reading the sensors in a predetermined sequence. Preferably, the sensors are individually identified (e.g., by numbers and/or letters), to facilitate processing the sensor outputs as they are scanned.

It should be noted that motion sensor array 22 may be constructed in a similar manner. Of course, if array 22 consists of a single longitudinal row of sensors, a common permanently connected signal path may be used as ground return with individual signal lines for each sensor.

It may be further noted that underwater wireless sensors exist and can be substituted for the wire matrix sensor activation arrangement illustrated in FIG. 2. It should also be understood that sensors suitable for use according to the invention are available in different sizes and that this must be taken into account in setting the spacing of the detector array 20. The spacing between the sensors should be such that adjacent sensors will detect the presence of an object above a certain size, e.g., a baby or other supine body but will ignore the presence of someone standing still for an extended period.

The motion sensors, on the other hand, may optionally be spaced according to their fields of view to provide full coverage without gaps, if desired.

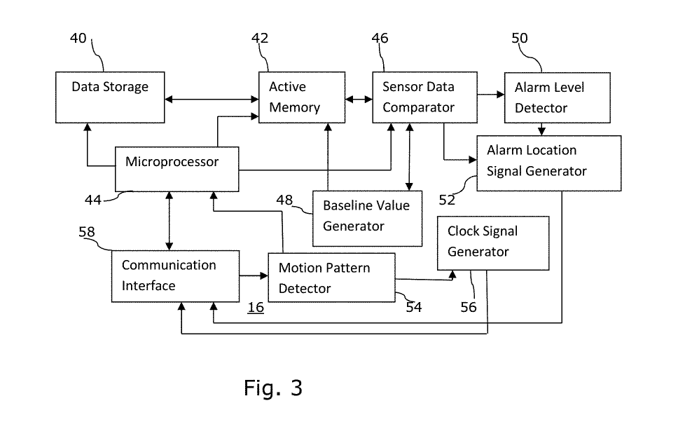

FIG. 3 is a simplified block diagram that illustrates one suitable embodiment of controller 16. As illustrated, controller 16 is comprised of a data storage unit 40, an active memory unit 42, a microprocessor 44, a sensor data comparator 46, a baseline value generator 48, an alarm level detector 50, an alarm location signal generator 52, a motion pattern detector 54, a clock signal generator 56, and a communication interface 58. As will be apparent to those skilled in the art, controller 16 may be implemented by a suitably programmed computer, or by a custom-built device comprised of 'ASICs.

The operation of controller 16 may best be understood with reference to the following description. When the system is activated, clock signal generator 56, under control of processor 44 sends scan control signals through interface 58 to interface 32 (FIG. 1) to activate the motion detectors in motion detector array 22 and to scan the outputs of sensors 28.

In the illustrated embodiment, baseline value generator 48 collects and averages all the sensor signals provided by sensor data comparator 26 to provide a reference value indicating a quiescent condition. The reference value is then compared with each of the sensor outputs to identify any output indication that substantially departs from the baseline value. If no such departure is found, further polling of the sensors is suspended, but interface 58 continues transmitting scan control signals for the motion detector array 22,

If the return signals indicate absence of motion in container 10, they system remains in this rest mode. If motion is detected, the system returns to active mode and scan control signals are again sent for sensors 28.

When the system receives a positive proximity signal, it is stored and compared with successive signals from the same sensor. If there is no change over a predetermined period, the system assumes that an immobile object is resting of the sensor.

As will be appreciated, unless the object is very small, nearby sensors are also likely to be activated. To provide an indication of the size and nature of the object, sensor data comparator collects the data from the nearby sensors and generates data indicating the location and contour of the immobile object. As will be understood, if the contour data indicates that the object might be person, or animal, or a large enough inanimate object, alarm level detector 50 activates alarm location signal generator 52 to provide an alarm signal of the desired kind.

The alarm signal can perform several functions, including notification of an attendant of a possible emergency and generating a positioning control signal to position camera 26 to view the area at which the immobile object is resting. If more than one camera is provided, selected ones may be directed to view the area. The attendant can then view the camera image data on a monitor to confirm the emergency and initiate appropriate action.

It should be understood that while a specific embodiment has been described in detail and several variations have been described, other variations are also possible. For example, in some embodiments, determination of a baseline sensor output may be dispensed with. Similarly, a rest mode characterized by continuous motion may be dispensed with. Alternatively, for unattended swimming pools, continuous motion would likely indicate the presence of an intruder and the imaging system can be activated to allow the attendant to observe the situation and initiate action against the intruder.

As yet another variation, use of an optical imaging system may be dispensed with, and image process software can be used to convert the detector outputs into a synthetic image.

In general, it should be s appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A system for detecting an immobile object in a container of liquid, the container having an accessible bottom, the system including:
At least one sensor being configured to provide a proximity signal output indicating the presence of at least a part of an object at the bottom of the container at the said sensor location;
a controller;
a communication channel connecting said sensor to the controller; and
an alarm signal generator,
wherein the controller is operative to scan the proximity signal output of said sensor in a repetitive sequence and responsive to a succession of proximity signals from said sensor that are substantially non-varying over a predetermined time period to activate the alarm signal generator.

2. A system according to claim 1, wherein said at least one sensor is comprised of an array of sensors positioned in a spaced relationship at the bottom of the container, each being configured to provide a proximity signal output indicating the presence of at least a part of an object at the bottom of the container at the sensor location.

3. A system according to claims 1, further including a visual image generator in communication with the controller to provide an image of the area of the container at which the immobile object is located.

4. A system according to claim 1, wherein the visual image generator includes a camera positionable to view selected areas of the surface of the liquid in the container; and
wherein the controller is further operative to activate the visual image generator to generate an image of the area of the surface of the liquid above the particular sensor.

5. A system according to claim 1, wherein the visual image generator is comprised of image processing software responsive to the sensor output signals to generate an image if the immobile object.

6. A system according to claim 1, further including at least one motion detector.

7. A system according to claim 1, wherein the sensors are arranged in a matrix array and are activated by row and column wires responsive to activation signals from the controller.

8. A system according to claim 7, wherein the sensors are integrated into a supporting platform that provides a waterproof environment for transmission of sensor output signals.

9. (canceled)

10. A system according to claim 7, wherein the sensors are integrated into the surface of the container at the time it is manufactured.

11. A system according to claim 1, wherein the controller is operative to generate a baseline reference value for the sensors and to compare the actual sensor outputs with the baseline value to determine the presence of the immobile object.

12. A system according to claim 1, wherein the sensors are one or more of piezoelectric sensors, capacitive sensors, and photoelectric sensors.

13. A system according to claim 1, wherein signals are transmitted between the container sensors and the controller either by wire or wirelessly.

14. A method for detecting an immobile object in a container of liquid having an accessible bottom, the method including:
positioning at least one sensor at the bottom of the container, said sensor configured to provide a proximity signal output indicating the presence of an object at the bottom of the container at the sensor location;
transmitting the proximity signals to a controller through a communication channel, wherein the controller is operative to detect a proximity signal from said sensor indicating an object that is constant for a predetermined period of time thereby indicating that the object is immobile; and
generating an alarm signal when an immobile object has been detected.

15. A method according to claim 14, wherein said sensor includes an array of sensors in a spaced relationship.

16. A method according to claims 14, further including generating a visual image of the area of the container at which the immobile object is located.

17. A method according to claim 14, wherein the visual image generator includes a camera, and further including positioning the camera to view selected areas of the surface of the liquid in the container.

18. A method according to claims 14, further including creating a visual image by performing image processing sensor output signals to generate an image if the immobile object.

19. (canceled)

20. (canceled)

21. (canceled)

22. (canceled)

23. (canceled)

24. A method according to claim 14, further including generating a baseline reference value for the sensors and comparing the actual sensor outputs with the baseline value to determine the presence of the immobile object.

25. A method according to claim 14, wherein the sensors are one or more of piezoelectric sensors, capacitive sensors, and photoelectric sensors.

26. A method according to claim 14, further including transmitting signals between the container sensors and the controller either by wire or wirelessly.
